(19) United States
(12) Patent Application Publication
(10) Pub. No.: US 2004/0107734 A1
(43) Pub. Date: Jun. 10, 2004

(54) Systems and methods for fabricating optical fiber preforms

(76) Inventors: Paresh Kenkare, Tucker, GA (US); Paul F. Glodis, Atlanta, GA (US)

Correspondence Address: Malvern U. Griffin III, SUTHERLAND ASBILL & BRENNAN LLP, 999 Peachtree Street, NE, Atlanta, GA, 30309-3996, US

(21) Appl. No.: 10/309,920

(22) Filed: Dec. 4, 2002

(51) Int. Cl. C03B 37/07; C03B 37/018

(52) U.S. Cl. 65/378; 65/417; 65/484; 65/485

(57) ABSTRACT

The present invention provides systems and methods for removing or decreasing the undesirable oscillations in MFD and dispersion in an OTDR trace of an optical fiber. In addition, the present invention removes the undesirable oscillations in core ovality of a preform fabricated by a vapor deposition technique. Briefly stated, the present invention comprises increasing the rotational rate of the substrate tube during the deposition process to between 50-65 rpm, preferably approximately 60 rpm.

### BACKGROUND OF THE INVENTION

I. Field of the Invention

The present invention generally relates to manufacturing optical fiber preforms, and more particularly, to reducing variations in mode field diameter, dispersion and polarization mode dispersion (PMD) in optical fibers drawn from preforms manufactured using the modified chemical vapor deposition technique (MCVD) or similar inside vapor deposition techniques.

II. Description of Related Art

In the manufacture of optical fiber, a glass preform is fabricated and then optical fiber is drawn from the glass preform in a draw tower. The glass preform may be fabricated using a number of different techniques, such as by the deposition of layers of matter on a substrate by vapor deposition. For example, modified chemical vapor deposition (MCVD) is a widely-used process for fabricating preforms wherein successive layers of cladding and core material are deposited on the inside surface of a substrate tube, which is made from high-quality glass. In MCVD, the substrate tube is placed in a lathe and rotated while a stream of vapor reactants passes through the center of the substrate tube. Individual layers of deposited material are turned into glass (vitrified) by a heat source, such as a torch, that moves back and forth along the length of the substrate tube. Other vapor deposition techniques utilized in fabricating preforms include, for example, plasma chemical vapor deposition (PCVD), outside vapor deposition (OVD) and vapor axial deposition (VAD).

Once the optical fiber has been drawn, it is typically transferred from the draw spool to a measurements spool and tested for optical quality. Quality issues in optical loss and other parameters such as mode field diameter and dispersion may be associated with localized flaws such as breaks or with finite sub-sections of the fiber length having non-optimum properties. A typical technique for measuring optical properties along the length of a fiber is by optical time domain reflectometry (OTDR), which involves transmitting pulses of light into one end of the fiber and analyzing the back scattered light. Measurements taken by OTDR are becoming increasingly important because buyers of optical fiber can utilize OTDR to quickly gauge the quality of the fiber along its length. The use of OTDR for calculating the mode field diameter (MFD) in optical fibers is well known and details relating to its use may be found in the Electronic Industries Alliance (EIA) standards—EIA-455-59, EIA-455-60, and EIA-455-61. The use of OTDR to calculate dispersion can be understood from the paper by C. Pask, “Physical Interpretation of Peterman's Strange Spot Size for Single-mode Fibers”, Electron. Lett., Vol. 20, No. 3, pp. 144-145, 1984 and from the paper by K. Nakajima, M. Ohashi and Y. Miyajima, “Evaluation of Chromatic Dispersion Distribution in a Single-Mode Fiber”, NTT Access Network Systems. Laboratories, Japan, OFMC 1997, pp. 235-240.

When a preform is manufactured using a vapor deposition technique, such as MCVD, it has been found that oscillations may occur with a spatial period of a few kilometers as seen in the fiber mode field diameter (MFD) and dispersion measurements recorded in an OTDR trace. For example, FIGS. 1A and 1B depict the MFD from an 1550 nm OTDR trace and 1310 nm OTDR trace, respectively, both of which show oscillations with a 4 kilometer (km) period. Similarly, FIGS. 1C and 1D depict the dispersion measurements from a 1550 nm OTDR trace and a 1310 nm OTDR trace, respectively, both of which show oscillations having a similar period of 4 km.

The oscillations in the OTDR traces, also referred to as ripples, are undesirable to the customer because it represents a non-uniformity in the optical property of the fiber. In addition, if the oscillations are at the lower or upper limits of acceptable MFD or dispersion measurements, then the oscillations may result in MFD or dispersion measurements that exceed the acceptable manufacturing limits, resulting in reduced process yield. Thus, it is desirable to minimize or eliminate the oscillations detected in the OTDR measurements of optical fiber drawn from preforms manufactured using deposition techniques.

The present inventors independently discovered that the spatial periodicity of the MFD or dispersion oscillations in the fiber corresponds to changes (or oscillations) with length in the core diameter of a preform fabricated using a vapor deposition technique. As well known, the core is the central portion of the light guiding refractive index structure built into the glass during the preform deposition process and the most significant factor in determining the fiber optical properties. The inventors further discovered that oscillations in the preform core diameter were also accompanied by oscillations in the preform core ovality. The preform core ovality is the percentage deviation from perfect azimuthal circularity of the preform core diameter at a given axial position. With reference to FIG. 2, shown is the core diameter of an MCVD preform that was measured over a 10 cm length of the preform by a series of refractive index profile scans with a 1 millimeter (mm) axial separation. The preform was fabricated with a substrate tube rotational rate of 20 rpm and a torch transverse velocity of 14.4 centimeter/minute (cm/min). The period of the oscillations is 0.72 cm and the maximum peak to valley amplitude is about 1% of the average core diameter. The periodicity of 0.72 cm in the preform was found to be linked to the ratio of the torch traverse velocity (cm-min⁻¹) and head stock rpm (min⁻) in the MCVD process (e.g., 0.72=14.4/20 cm/rotation). In addition, when the length stretching ratio in the preform to fiber draw process is accounted for, the period of oscillation (0.72 cm) of the preform core diameter matches the period of oscillation (4 km) in MFD and dispersion seen on the OTDR traces of the drawn fiber. Finally, it is noted that the magnitude of the dispersion fluctuations in the OTDR trace corresponds with waveguide calculations of the fiber dispersion fluctuations that would be expected for this type of fiber design given the 1% core diameter variations measured in the preform profile. Taken together, these observations demonstrate that the oscillations seen in the fiber OTDR trace are caused by the core diameter variations in the MCVD preform.

The present inventors discovered that a similar analysis applies to the measured core ovality (in %) of the above perform. The periodicity of the oscillations was found to be 0.72 cm and the peak to valley amplitude of the oscillations can be as much as 1.2% (from 0.4% to 1.6%). Such oscillations in core ovality will result in parts of the preform having significantly higher core ovality than would be expected based on the average preform ovality. The fiber drawn from these parts of the preform may have higher than average PMD which would present a quality issue.

One technique proposed for removing the oscillations occurring in OTDR measurements is found in U.S. Pat. No. 5,518,516 to Garnham (“the '516 patent”). In the '516 patent, it is suggested that the oscillations or ripples in the OTDR trace correspond to variations in the longitudinal section profile of the layers of the preform deposited during the deposition process. In particular, each deposited layer has an undulating profile defined by a ridge which appears to be helical in form. The solution proposed in the '516 patent is to vary the speed of the rotating glass substrate in the lathe between all or some of the deposition passes of the heat source, or alternatively vary the rate of traverse of the heat source between deposition passes of the heat source. The '516 patent proposes that changing the rate of rotation or the rate of traverse of the heat source causes the deposition profiles to fall out of phase from layer to layer, thereby minimizing the oscillations in the OTDR trace. A specific example given in the '516 patent alternates the rate of rotation of the substrate tube back and forth between 20 rpm and 50 rpm each traverse of the heat source.

The present inventors independently derived the theory that the oscillations in the OTDR measurements may be reduced by varying the rotational rate of the substrate tube, which they subsequently found out was suggested by the '516 patent as a method for reducing oscillation in the OTDR measurements of a fiber. When the present inventors attempted to test this theory, the results were not satisfactory. For example, with reference to FIG. 3, the refractive index profile scans of an MCVD preform in which the rotational rate of the substrate tube was alternated between 20 rpm and 50 rpm through successive core deposition passes show that the oscillations in the core diameter were not materially reduced. The refractive index profile scans were taken with one millimeter axial separation, and the core diameter oscillations are at a period of approximately 0.72 cm, which corresponds to the oscillations found in an MCVD preform fabricated with a consistent rate of rotation of the glass substrate at 20 rpm. The amplitude of the core diameter oscillations is also substantial enough to influence the OTDR profiles of the fiber drawn from such a preform. Thus, while the deposited core layers are out of phase, oscillations in the core diameter correspond to those layers deposited at the lower rotational rate are still present. Thus, there exists an unsatisfied need in the industry for a method to decrease or remove the undesirable oscillations in the MFD and dispersion measurements in an OTDR trace. There also exists a need to decrease or eliminate the heretofore undiscovered oscillations in core ovality as observed through the refractive index profile preform.

### SUMMARY OF THE INVENTION

The present invention provides systems and methods for removing or decreasing the undesirable oscillations in MFD and dispersion in an OTDR trace of an optical fiber drawn from preforms fabricated using a vapor deposition technique. In addition, the present invention removes the undesirable oscillations in core ovality of a preform. Briefly stated, the present invention comprises increasing the rotational rate of the substrate tube during the deposition process to between 50-65 rpm, preferably approximately 60 rpm. The higher rotational rate increases the azimuthal uniformity of the deposition tube temperature profile in the torch hot zone and decreases the importance of asymmetric effects such as buoyancy and gravity thus contributing to a more uniform deposition of material during the vapor deposition process. Advantageously, by increasing the uniformity of the material deposition, the core diameter and core ovality become more uniform, which results in a reduction in the oscillation in the OTDR measurements and a decrease in fiber PMD. Thus, the present invention increases optical fiber manufacturing yield.

In accordance with an embodiment of the present invention, a method for fabricating a preform from which an optical fiber can be drawn comprises providing a hollow glass substrate tube having a longitudinal direction and inner walls defining a central bore, rotating the substrate glass tube at a substantially constant rotational rate that is sufficient to reduce the traverse speed/rotation speed related core diameter oscillation peak to valley amplitudes in the preform to less than 0.1% of the average core diameter, and heating the substrate tube while passing vaporous reactants through the central bore of the substrate tube to cause formation of material layers on the inner walls of the substrate tube. Preferably, the rotational rate is between 50 rpm and 65 rpm. The decrease in core diameter oscillation amplitude will be accompanied by decrease in the amplitude of the core ovality oscillation. Lastly, preferably the material layers are deposited by modified chemical vapor deposition.

In accordance with another embodiment of the present invention, a system for fabricating a perform from which an optical fiber can be drawn comprises a lathe for receiving a hollow glass substrate tube having a longitudinal axis and inner walls defining a central bore about the longitudinal axis, wherein the lathe is capable of rotating the substrate tube at an operational speed sufficient to reduce the traverse speed/rotation speed related core diameter oscillation amplitudes in the preform to less than 0.1% of the average core diameter, a torch for heating the substrate tube while passing vitreous materials through the central bore of the substrate tube to cause formation of material layers on the inner walls of the substrate tube, and a controller that maintains the rotational rate of the lathe at the operational speed substantially the same during substantially all the passes of the torch. Preferably, the operational speed is between 50 rpm and 65 rpm, and the torch has a traverse velocity of approximately 14.4 centimeter/minute. The decrease in the amplitude of the core diameter oscillation will be accompanied by a decrease in the amplitude of the core ovality oscillation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1(a) is a graph showing the mode field diameter from a 1550 nm OTDR trace of a fiber made in accordance with the prior art, which shows oscillations with a four kilometer period.

FIG. 1(b) is a graph showing the mode field diameter from a 1310 nm OTDR trace of a fiber made in accordance with the prior art, which shows oscillations with a four kilometer period.

FIG. 1(c) is a graph showing the dispersion from a 1550 nm OTDR trace of a fiber made in accordance with the prior art, which shows oscillations with a four kilometer period.

FIG. 1(d) is a graph showing the mode field diameter from a 1310 nm OTDR trace of a fiber made in accordance with the prior art, which shows oscillations with a four kilometer period.

FIG. 2 is a graph showing the core diameter along the axial length of a preform made in accordance with the prior art.

FIG. 3 is a graph showing the core diameter along the axial length of a preform, the perform being formed by alternating the headstock rotational speed between 20 rpm and 50 rpm through successive core deposition passes.

FIG. 4 is a schematic block diagram illustrating a perspective view of a glass-working lathe.

FIG. 5 is a graph showing the core ovality along the axial length of a preform made in accordance with the prior art.

FIG. 6 is a graph showing the core ovality along the axial length of a preform, the preform being formed by rotating the headstock at 40 rpm for seven core deposition passes and then 10 rpm for three core deposition passes.

FIG. 7 is a graph showing the core diameter along the axial length of a preform made in accordance with an embodiment of the present invention, which shows the elimination of core diameter oscillation.

FIG. 8 is a graph showing the core ovality along the axial length of a preform made in accordance with an embodiment of the present invention, which shows a significant decrease in the amplitude of core ovality oscillations.

FIG. 9 is a flowchart of a method for fabricating an optical preform in accordance with an embodiment of the present invention.

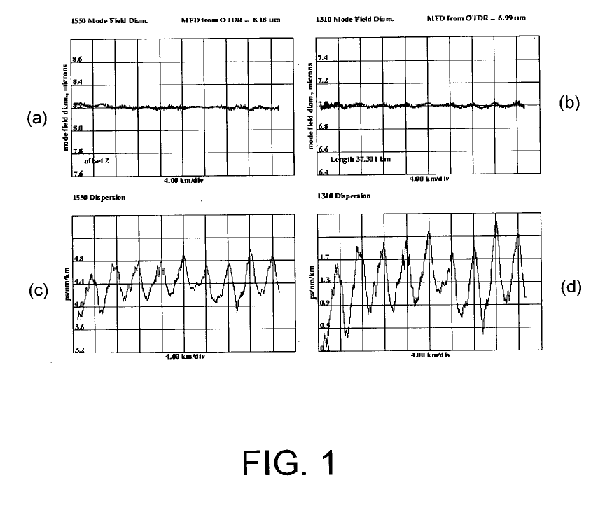

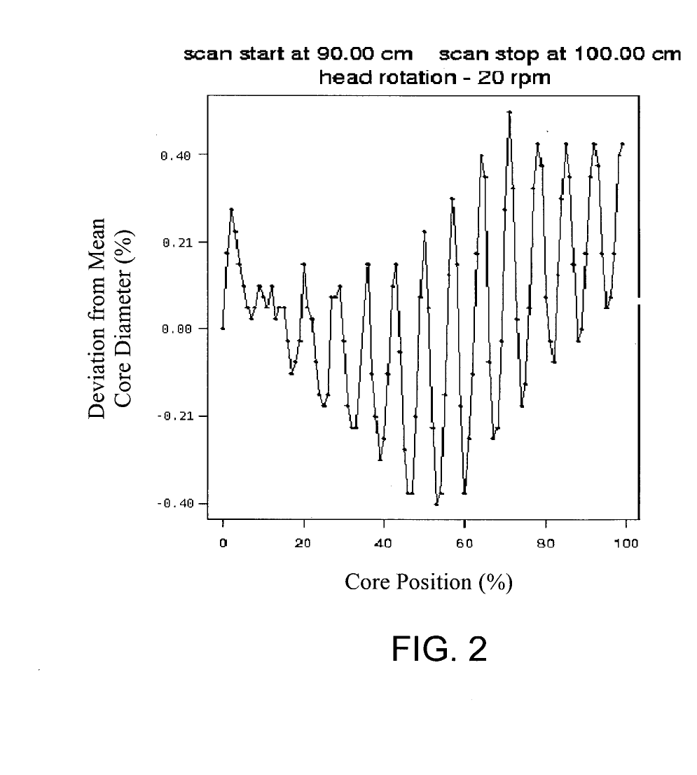

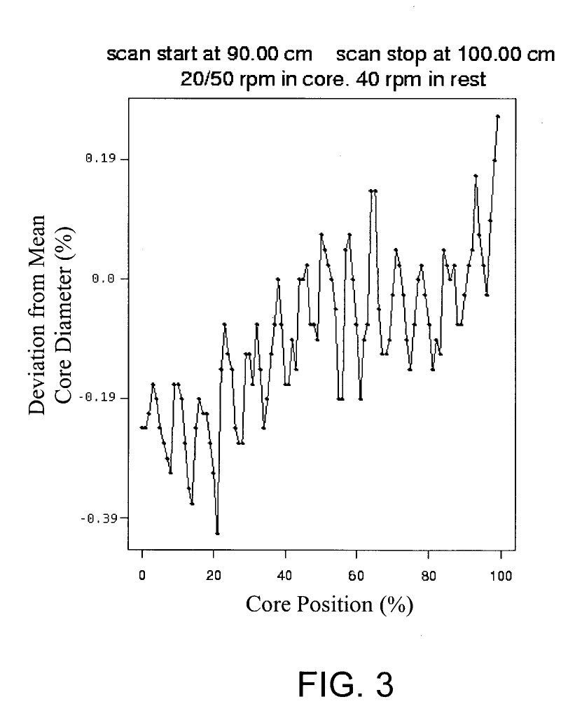

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides systems and methods for fabricating a glass preform with more uniform deposition of core layers in the axial direction. The present invention obtains this by rotating the glass substrate at a higher rpm, preferably at approximately 60 rpm. The increased rotational rate increases the symmetry of the temperature and decreases the effects of buoyancy and gravity during the deposition process. The increased rotational rate also decreases oscillations in ovality.

The present invention applies to the fabrication of preforms by inside vapor deposition techniques, e.g., those fabricated by Modified Chemical Vapor Deposition (MCVD) and Plasma Chemical Vapor Deposition (PCVD) or fundamentally similar processes. By way of illustration, and not limitation, an MCVD process is used to demonstrate an application of the invention.

Modified Chemical Vapor Deposition

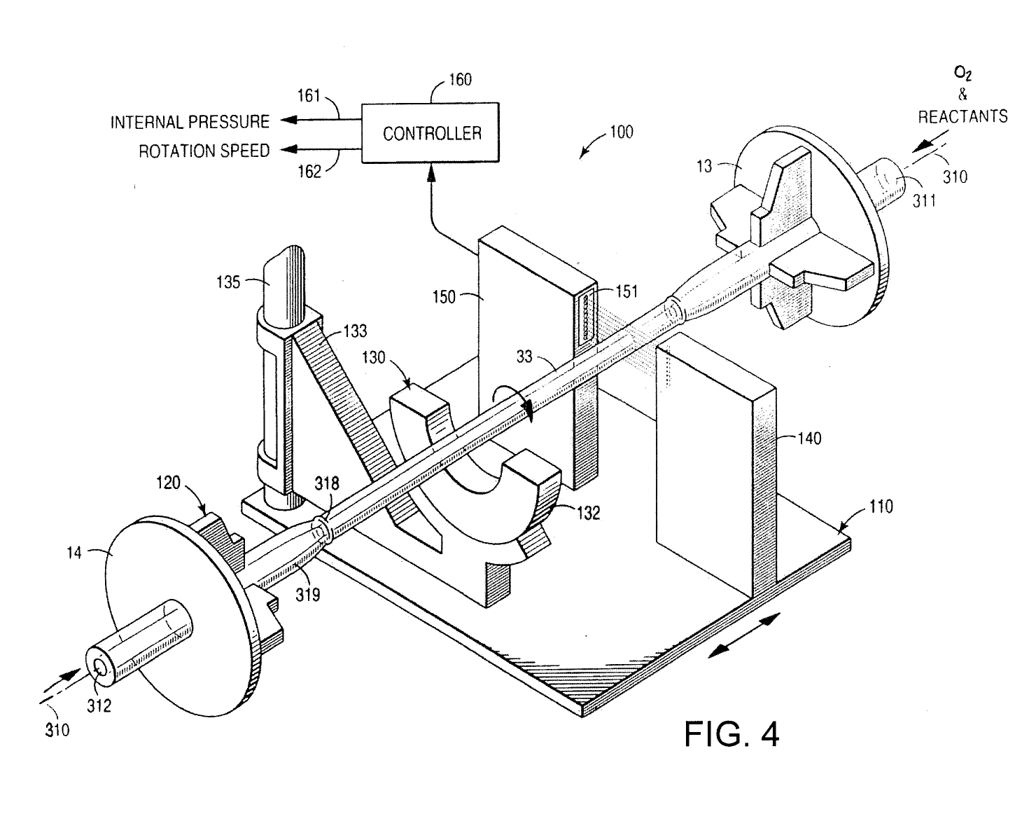

Reference is made to FIG. 4 which shows an apparatus, designated generally by the numeral 100, for heating a glass substrate tube 33 to manufacture a core rod by the MCVD process. Specific details of the MCVD process are disclosed in U.S. Pat. No. 4,217,027 and in chapter 4 (particularly pages 156-162) of the textbook Optical Fiber Telecommunications II, Academic Press, Inc., @988 AT&T and Bell Communications Research, Inc.—both of which are hereby incorporated by reference.

The apparatus 100 includes a glass-working lathe 120 having a headstock 13 and a tailstock 14, which are each driven off a common shaft (not shown), and which are used to support the glass substrate tube 33 in such a manner that it can be rotated. The substrate glass tube 33 is positioned in the lathe with one of its ends in the headstock 13 and with its other end connected by a welded joint 318 to an exhaust tube 319. The exhaust tube 319 is supported in the tailstock 14 of the lathe 120. In the MCVD process, a constantly moving stream of reactants (e.g., silicon tetrachloride) and oxygen is directed through the interior of the substrate tube 33. This stream includes dopants such as germanium to produce the desired index of refraction in the finished lightguide fiber. During each pass, doped reactants are moved into the tube from its headstock end while spent gases are exhausted at the tailstock end.

The lathe 120 also includes a carriage 110, which is mounted for reciprocal motion along the lathe. Mounted on the carriage 110 is a torch assembly which is designated generally by the numeral 130. The torch assembly 130 includes a housing 132 supported by a bracket 133 which, in turn, is supported from a post 135 that is mounted on carriage 110. The torch assembly 110 is adapted to cause a flow of combustible gasses to produce flames which are directed toward the tube 33. By confining the heat from the burning gases to a desired surface area of the tube, the torch assembly provides a reaction temperature (illustratively, 1700°-1900° C.) within a zone of heat. The mounting of the torch assembly 130 on the carriage 110 and its movement relative to the tube 33 causes the zone of heat to be moved along the length of the rotating tube. Through adjustment of the bracket 133, an operator may move the torch assembly 130 within any one of a range of distances from the tube 33 or to any one of a plurality of positions about and spaced from the tube.

The torch assembly 130 may be constructed to be either a surface-mix unit or a premix unit. In a surface-mix unit, each of the two combustible gasses is fed through the torch assemble 130 and are mixed together within a confinement provided between the torch assembly and the tube. On the other hand, in the premix unit, the combustible gasses are premixed prior to their flow through the torch assembly and into the vicinity of the confined tube 33. The housing 132 and its nozzles (not shown) may be cooled in order to provide a clean gas which prevents oxidation and resulting flaking of the material of which the housing and the walls are made. A coolant, such as chilled water, for example, is fed into conduits within the housing in order to provide the necessary cooling.

During the deposition process, the torch assembly 130 slowly traverses the length of the rotating tube 33 from the headstock end 13 of the lathe 120 toward its tailstock end 14 and then quickly returns to the headstock end. It is noted that reactant gasses are fed into an input port 311 at the headstock end and are exhausted from output port 312 at the tailstock end. However, in order to maintain a suitable amount of pressure within tube 33 to keep its diameter from varying, nitrogen is fed into exhaust port 312, although the net flow of gasses through the tube is from the headstock end to the tailstock end. Each pass of the torch assembly causes a single layer of silicon dioxide and dopants to be fused onto the inner wall of the tube. The composition of the various layers is determined by the composition of the reactant gasses and may be varied to obtain a gradation in index of refraction to obtain a desired profile.

Apparatus 100 may also include a machine-vision system mounted on the carriage 110 for causing the substrate tube 33 to have a central longitudinal axis 310-310 which is a straight line, and for measuring and controlling the outside diameter of the substrate tube. The machine-vision system comprises a source of laser light 140 and a detector 150 that are positioned on opposite sides of tube 33. Detector 150 includes a linear array of photo-diodes 151 that detect the shadow cast by the tube.

Controller 160 responds to electrical signals from detector 150 to control the rotation speed of the tube and to control the gas pressure within the tube. The laser source 140 and the detector 150 are positioned to monitor that portion of the tube which has just been heated. Preferably, the Source 140 and the detector 150 are positioned between the torch assembly 130 and the headstock 13 during deposition, and between the torch assembly 130 and the tailstock 14 during collapse. If the tube 33 is not perfectly straight, then its shadow will wobble up and down on the array of photodetectors 151. Controller 160 responds to such wobble by varying the rotation speed of the tube 33 according to its angular position. Output 162 provides an electrical signal for controlling rotation speed. As one might expect, rotation speed is slower when the angular position of the tube is such that it is bowed upward; and rotation speed is faster when the angular position of the tube is such that it is bowed downward. Accordingly, gravity is used to straighten the tube. Detector 150 also monitors the diameter of tube 33. In the event that the diameter is smaller than desired, controller 160 responds on output 161 by increasing the pressure of oxygen flow into port 312. In the event that the diameter is larger than desired, controller 160 responds on output 161 by decreasing the pressure of oxygen flow into port 312. In either situation, the net flow of gasses through the tube 33 is still in the direction from the headstock 13 toward the tailstock 14.

Following the deposition of core and cladding materials, the substrate tube 33 is collapsed to form a solid core tube by heating it to a higher temperature than during deposition. The wall of the tube 33 is pinched together adjacent to its tailstock end to prevent the entry of moisture and other contaminants into the tube while it is being collapsed. During collapse, the torch assembly 130 now moves from tailstock to headstock in a number of passes. At the end of each pass, the carriage 110 is returned rapidly to the tailstock to commence another cycle. Although the direction of travel of the torch assembly 130 in its operative condition during the collapse mode is preferably opposite to that in the deposition mode, it may be the same. In that event, the tube 33 is not pinched off completely at the tailstock end in order to allow for the removal of gases. Otherwise, an undesirable pressure build-up in the tube could occur.

Tube Collapse Procedure

The collapse procedure usually starts with a series of shrinking passes in the same direction as the deposition. During collapse, a rotation speed of about forty-three (43) revolutions per minutes is used. The laser 140 and detector 150 are positioned to follow the torch assembly 130. When the bore of the tube 33 is sufficiently small, one or more etching passes are carried out to remove a small amount of material from the inside surface. This material has been depleted of germanium during the previous shrinking passes and, if incorporated into the final collapsed rod, would cause a center dip in the refractive index profile. SF₆ is the preferred etching gas, although C₂F₆ may be used, along with O₂ and Cl₂, and the etching passes are again in the original deposition direction. (This etching step is one reason why one cannot simply close the tailstock end of the tube 33 after deposition and perform all the collapse passes from tail to head.) Several more shrinking passes may follow the etch passes. The tube 33 is then sealed at the tailstock end and the collapse is finished with one or more passes in the tail-to-head direction with the laser source 140 and detector 150 still following the torch assembly 130.

If wobble control is employed, then the laser source 140 and detector 150 are switched to the opposite side of the torch assembly 130 prior to or during the first pass in the collapse mode. This may be done manually or automatically. The laser 140 and detector 150 need to be positioned on the side of the torch assembly where the tube is softer and, thus, more susceptible to being shaped.

Oscillations in Core Ovality

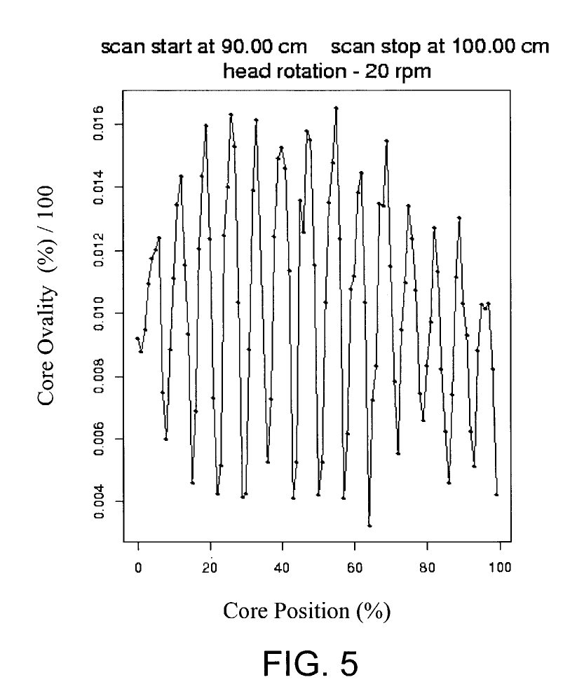

The present inventors discovered through the refractive index profile scans that oscillations in core diameter are accompanied by significant core ovality oscillations resulting in regions of the preform having high core ovality. FIG. 5 shows the results of a series of refractive index profile scans with 1 mm axial separation performed on an MCVD preform fabricated with a substrate tube rotational rate of 20 rpm and a torch traverse velocity of 14.4 cm/min. The periodicity of the oscillations in the percent core ovality is 0.72 cm, which is the same periodicity as that of the core diameter oscillations of other preforms fabricated at the same rotational rate and torch velocity. Unless this oscillatory deposition effect is minimized, it will be difficult to obtain core ovality uniformly less than about 1% over the preform length even when starting with the best quality substrate tubes. It is believed that maintaining core ovality less than 1% will be beneficial in maintaining uniformly low PMD in the drawn fiber.

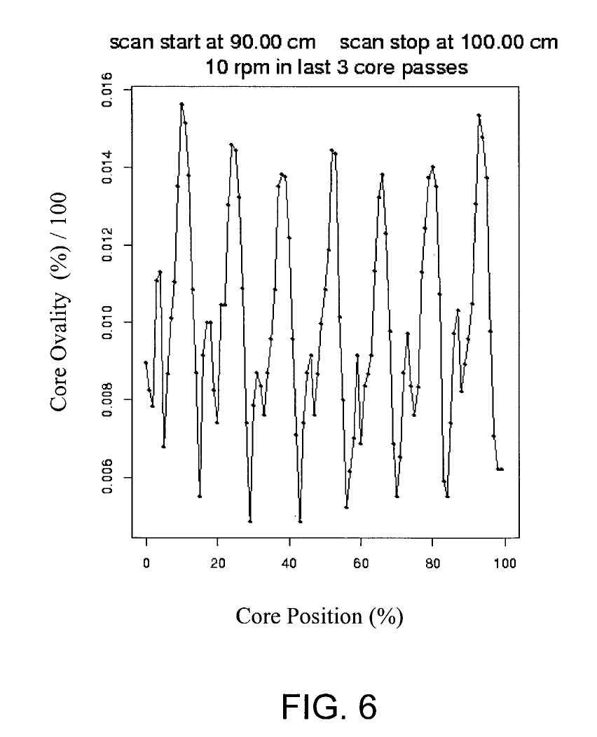

In an effort to resolve the ovality problem using the technique of varying the rotational rate of the substrate tube, an MCVD preform was manufactured with the first 7 of 10 core torch passes at a rotational rate of 40 rpm and the last 3 core torch passes at a rotational rate of 10 rpm. Of the last 3 core passes, 1-2 are etched away before completely collapsing the tube. However, as depicted in FIG. 6, the oscillations in percent core ovality were still present, and the periodicity (1.4 cm) of the oscillations corresponded to preforms fabricated at 10 rpm rotational rate (1.4 cm=14.4 cm-min⁻¹/10 min⁻¹). These results suggest that even if 1 or 2 deposition passes are made at low rpm's they still leave their oscillatory imprint on the rest of the core layers, probably because the low rpm deposited layers have non-uniform deposition of a higher amplitude than the high rpm deposited layers. During the collapse process these high amplitude layers dominate. Thus an out of phase solution obtained through running different core passes at different rpm, as proposed by the '516 patent, will not necessarily eliminate the oscillations (in core diameter and ovality) because the core region will still have the imprints corresponding to the layers deposited at the lowest rpm.

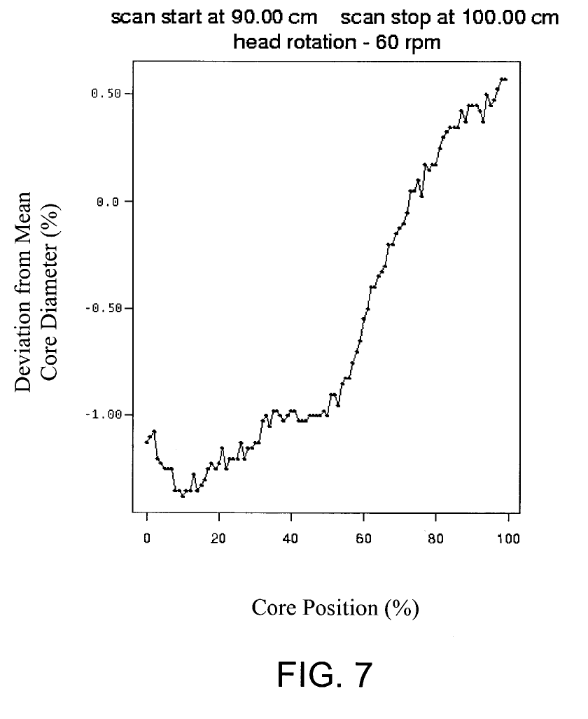

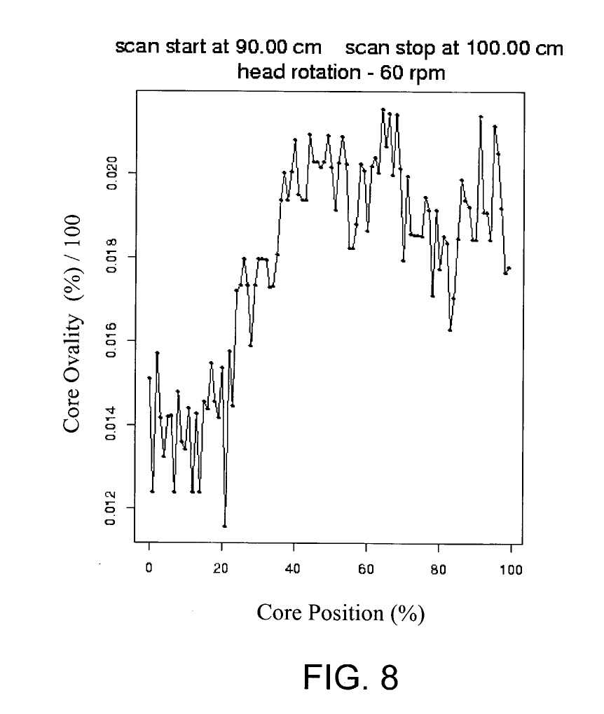

The present inventors then determined that increasing the rotational rate of the substrate tube during the deposition process to between 50-65 rpm, preferably 60 rpm, results in an elimination or significant decrease in the core diameter oscillation and core ovality oscillation as detected through 1 mm scans of the preforms. For example, FIGS. 7 and 8 show a core diameter plot and core ovality plot, respectively, obtained from an MCVD preform manufactured at 60 rpm and a torch traverse velocity of 14.4 cm/min. The plot points were taken from the results of high axial resolution (1 mm) refractive index profile scans of the preform along its length. As is evident, the oscillations are essentially removed from the preform and/or the amplitude and period of the oscillation is dramatically reduced. It is believed that by increasing the rotational rate to 60 rpm, the parameters such as temperature, buoyancy and gravity, that contribute to non-uniform deposition in the MCVD process, become less of a problem and the deposition is more uniform in the radial and azimuthal directions. Such symmetry is obtained simply by spinning the substrate tube at a higher rpm. The classical spiral deposition profile seen in the MCVD process is thus significantly reduced in pitch and amplitude resulting in a more uniform core diameter, and hence results in more uniform MFD and dispersion OTDR traces of the fiber drawn from such the preform.

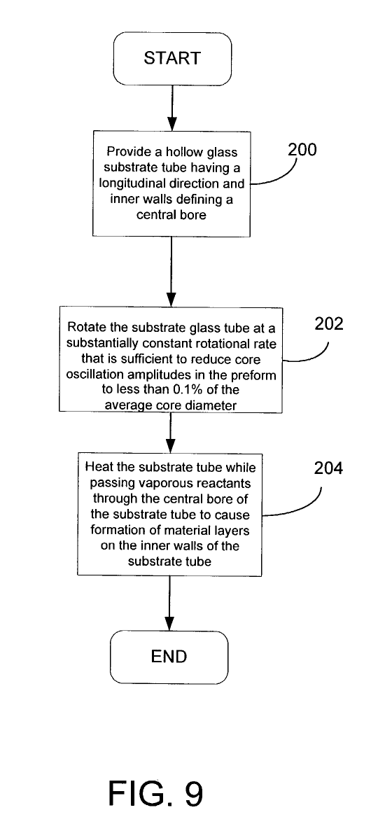

With reference to FIG. 9, a method for fabricating a preform in accordance with an embodiment of the present invention is shown. At block 200, a hollow glass substrate tube with a longitudinal direction and inner walls defining a central bore is provided. The substrate glass tube is rotated, such as by a lathe, at a substantially constant rotational rate that is sufficient to reduce the traverse speed/rotation speed related core oscillation amplitudes in the preform to less than approximately 0.1% of the average core diameter, as indicated by block 202. The substrate tube is then heated while passing vaporous reactants through the central bore of the substrate tube to cause formation of material layers on the inner walls of the substrate tube, as indicated by block 204.

A reduction in peak to valley amplitude of the traverse speed/rotation speed related core diameter oscillations to below approximately 0.1% of the average core diameter and a reduction in peak to valley amplitude of the core ovality oscillations to below approximately 0.3% is found in the performs fabricated in accordance with an embodiment of the present invention. The reduction in amplitude of the oscillations is also accompanied by a decrease in the oscillation period from 0.7 cm (at 20 rpm) to 0.24 cm (at 60 rpm). The reduction in core diameter oscillations amplitude will result in a reduction in fiber OTDR dispersion oscillation amplitude. The amplitude of the dispersion and mode field diameter ripples in the fiber OTDR traces is a function of the sensitivity of the fiber dispersion and mode field diameter to changes in the index profile. For a fiber with relatively high dispersion sensitivity to profile changes, a 1% change in perform core diameter could result in a fiber dispersion change of 0.5 ps/nm-km. If the oscillatory variation in core diameter can be limited to 0.1%, the dispersion variation will accordingly be 0.05 ps/nm-km which is an order of magnitude improvement. Thus, the combination of greatly decreased amplitude and period provided by the present invention results in a near elimination of noticeable ripple in the OTDR dispersion and mode field diameter traces even in fibers with high sensitivity to profile changes.

In addition, the reduction in amplitude and period of the core ovality oscillations will remove a possible cause of high PMD of the drawn fiber because sections of the fiber which earlier corresponded to the high ovality regions (cyclical peaks) will now have significantly lower ovality

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for fabricating a preform from which an optical fiber can be drawn, comprising:
providing a hollow glass substrate tube having a longitudinal direction and inner walls defining a central bore;
rotating the substrate glass tube at a substantially constant rotational rate that is sufficient to reduce core diameter oscillation amplitudes in the preform to less than approximately 0.1% of average core diameter of the preform; and
heating the substrate tube while passing vaporous reactants through the central bore of the substrate tube to cause formation of material layers on the inner walls of the substrate tube.

2. The method of claim 1, wherein rotating the substrate tube includes rotating the substrate tube at between 55 rpm and 65 rpm.

3. The method of claim 1, further comprising drawing the optical fiber from the preform.

4. The method of claim 1, further comprising taking optical time domain reflectometry measurements of the optical fiber.

5. The method of claim 1, wherein the core oscillation amplitudes include core diameter oscillation amplitudes.

6. The method of claim 1, wherein the core oscillation amplitudes include core percent ovality oscillation amplitudes.

7. The method of claim 1, wherein the material layers are deposited by modified chemical vapor deposition.

8. A system for fabricating a preform from which an optical fiber can be drawn, comprising:
a lathe for receiving a hollow glass substrate tube having a longitudinal axis and inner walls defining a central bore about the longitudinal axis, wherein the lathe is capable of rotating the substrate tube at an operational speed sufficient to reduce core diameter oscillation amplitudes in the preform to less than approximately 0.1% of average core diameter of the preform;
a torch for heating the substrate tube while passing vitreous materials through the central bore of the substrate tube to cause formation of material layers on the inner walls of the substrate tube; and
a controller that maintains the rotational rate of the lathe at the operational speed substantially the same during substantially all the passes of the torch.

9. The system of claim 8, wherein the operational speed is between 55 rpm and 65 rpm.

10. The system of claim 9, where the torch has a traverse velocity of approximately 14.4 centimeter/minute.

11. The method of claim 1, wherein the core oscillation amplitudes include core diameter oscillation amplitudes.

12. The method of claim 1, wherein the core oscillation amplitudes include core percent ovality oscillation amplitudes.
